(19) United States
(12) Patent Application Publication
(10) Pub. No.: US 2009/0138819 A1
(43) Pub. Date: May 28, 2009

(54) WINDOW SWITCH SYSTEM

(75) Inventor: SHYANG-LIN YU, TAICHUNG CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: A FOUNDRY TECHNOLOGY CO., LTD., TAIPEI COUNTY (TW)

(21) Appl. No.: 11/944,764

(22) Filed: Nov. 26, 2007

(51) Int. Cl. G06F 3/048

(52) U.S. Cl. 715/802

(57) ABSTRACT

A system for switching an opened window in a computer system between a display state and a hide state includes a mouse and a window switch system. The mouse has a switch key and a signal control unit. The window control system includes a window recording unit, a display control module, a window state switch module and a signal processing unit. When the user presses the switch key to output a switch signal from the mouse to the window control system, the window state switch module changes the state of the opened window, and then, the display control module executes the altered result and outputs the result to the screen in the computer system, thereby achieving the purpose of switching the computer window between the display and the hide states, so as to prevent the information shown on the screen from being seen by unauthorized persons.

### BACKGROUND OF THE INVENTION

1. Field of the Invention

The present application is related to a computer window switch system for randomly hiding or displaying the window, and more particularly to a system capable of switching a computer window through an input device.

2. Description of Related Art

Owing to the fast growth of computer technology, more and more people depend on computers in their daily life. However, when using a computer, no matter whether in office or at home, there is the need to avoid important data being shown on the screen and displayed to unauthorized persons.

For solving this problem, a solution of the prior art consists in a special screen protector on the display which lowers the chance of unauthorized viewing of data by reducing the visual angle. However, if the unauthorized viewer adjusts the position or viewing angle to face the center of the screen, then he or she can easily catch the information shown on the screen, and the screen protector is circumvented.

In another system, the user can simultaneously press down plural functional keys in order to minimize the window, so that only the program's or window's name will be shown on the toolbar at the bottom of the screen, and the user can recover the program or window through click on the toolbar. However, for achieving this operation, the user has to press multiple keys at the same time which actually is inconvenient and takes more time. Besides, even though the program or window has been minimized to the toolbar, other viewers still can recognize the name thereof and obtain some information. Therefore, for the user who needs to completely hide some information, this is still inadequate.

Consequently, there is the need to provide a system capable of rapidly switching the computer window into a hidden state so as to immediately and completely hide the data and information shown on the computer screen.

### SUMMARY OF THE INVENTION

The object of the present application is to provide a system for rapidly hiding the window shown on a computer screen, so as to protect data and information of the user.

For achieving the object described above, the present invention provides a window switch system suitable for a computer system. The window switch system includes a mouse and a window control system. The mouse has a switch key and a signal control unit, wherein the signal control unit outputs a switch signal to the window control system as the switch key is pressed. The window control system includes a window recording unit, a display control module, a window state switch module and a signal processing unit.

The window recording unit is used for recording opened windows in the computer system and variables representing the state of the opened window, wherein the variable is changed between a value representing the display state and a value representing the hide state of the opened window on the screen.

The display control module is used for executing a display operation or a hide operation of the opened window(s) according to the corresponding variable recorded in the window recording unit.

The window state switch module is used for switching the variable recorded in the window recording unit and controlling the display control module to execute the display operation or the hide operation according to the changed variable.

The signal processing unit is used for receiving the switch signal and, according thereto, controlling the window state switch module to switch the variable recorded in the window recording unit.

When the user presses the switch key on the mouse, the signal control unit inside the mouse outputs a switch signal. After the switch signal is received by the signal processing unit 134 of the window control system 132, the process unit controls the window state switch module to change the variable recorded in the window recording unit. Then, the switch module causes the display control module to hide the window according to the changed variable. Moreover, if he or she wants to recover the hidden window, the user only needs to press again the switch key on the mouse, and then the window switch system will once again switch the window state so as to display the window.

Through the above descriptions according to the present application, the display and hide states of the computer window can be easily and rapidly switched, so that the user has a rapid control over the system, thereby achieving the purposes of immediately hiding the computer information and also more effectively managing the information shown on the screen.

### BRIEF DESCRIPTION OF THE DRAWINGS

The foregoing aspects and many of the attendant advantages of this application will be more readily appreciated as the same becomes better understood by reference to the following detailed description, when taken in conjunction with the accompanying drawings, wherein:

FIG. 1 is a block diagram showing the window switch system according to an embodiment of the present application;

FIG. 2 is a flow chart showing the steps of switching windows according to an embodiment of the present application;

FIG. 3A is a schematic view showing the display state before window switching according to an embodiment of the present application;

FIG. 3B is a schematic view showing the hide state after window switching according to an embodiment of the present application;

FIG. 4A is a schematic view showing the picture for setting window state according to an embodiment of the present application;

FIG. 4B is a schematic view showing the setting of partial windows (before switching) according to an embodiment of the present application;

FIG. 4C is a schematic view showing the setting of partial windows (after switching) according to an embodiment of the present application; and

FIG. 5 is a schematic view showing the mouse according to an embodiment of the present application.

### DETAILED DESCRIPTION OF PREFERRED EMBODIMENTS

It is very common to use a mouse to operate a computer system. When utilizing the mouse, the user may press few keys on the mouse to control the computer system, and as compared with other input devices (such as, keyboard, writing pad or sound controlled device), the mouse is advantageous of not only easy operation, but also perfectly cooperative with user's hand, so that if the user needs to immediately hide the window, pressing the key on the mouse to trigger this operation will be a best and easiest way.

Therefore, the embodiment described below illustrates a window switch system utilizing the mouse as the device to generate a switch signal for triggering window switch. In the window control system, a signal processing unit is included for receiving the switch signal from the mouse, and controlling a window switch module in the window control system to change the state variable of the window to be switched in a window recording unit. Then, the switch module causes a display control module to execute a switch between displaying and hiding of the window on the screen.

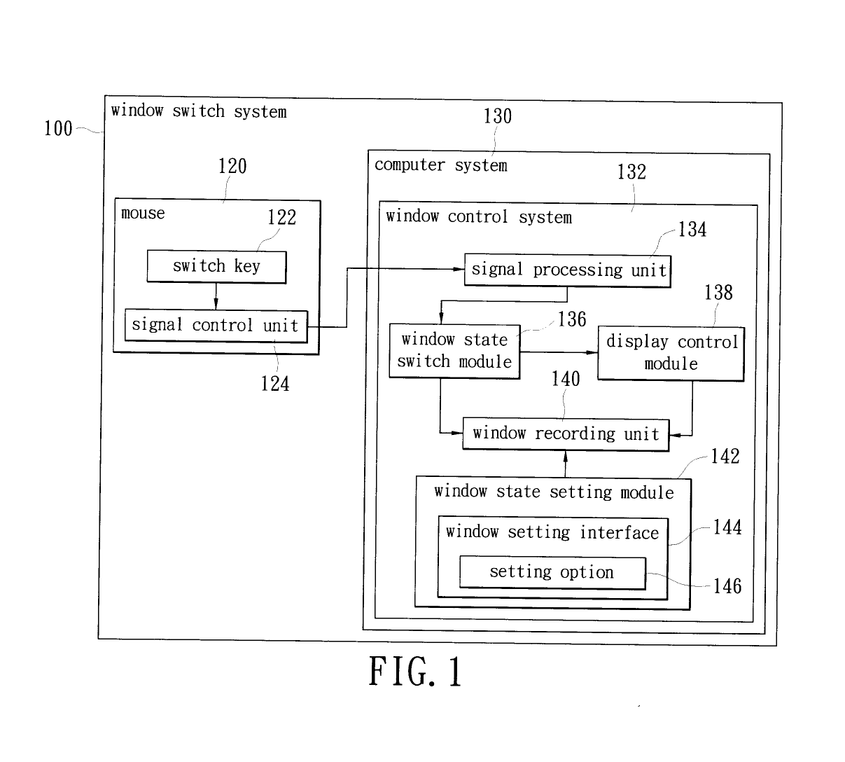

Please refer to FIG. 1, which is a block diagram showing a window switch system in an embodiment according to the present application. The window switch system 100 includes a mouse 120 and a window control system 132, wherein the window control system 132 is mounted in a computer system 130. The mouse 120 includes a switch key 122 and a signal control unit 124, wherein when the switch key 122 is pressed by the user, the signal control unit 124 can accordingly generate a switch signal to output to the window control system 132. In this embodiment, the indicated switch key can be an additional key, for example, the fourth key, on the mouse, but not limited.

The window control system 132 includes a signal processing unit 134, a window switch module 136, a display control module 138, a window recording unit 140 and a window state setting module 142. The window recording unit 140 records the opened window(s) in the computer system 130, and also the variable representing the state of each opened window, namely, “display state” and “hide state”. The display control module 138 accesses the contents recorded in the window recording unit 140 and executes a displaying or hiding operation of each window according to the state variable. The window state setting module 142 can be set to change the window state in the window control system 132.

The window state switch module 136 switches the state variables recorded in the window recording unit 140 and controls the display control module 138 to execute the displaying or hiding operation according to the changed state variable. The signal processing unit 134 receives the switch signal outputted by the signal control unit 124, and according thereto, controls the windows switch module 136 to notify the window recording unit 140 to change the state variable.

The switch key 122 is mounted on the housing of the mouse, so that when the user presses the key for switching the state of the window, the signal control unit 124 can produce a switch signal and transmit thereof to the window control system 132.

The signal processing unit 134 in the window control system 132 receives the switch signal from the mouse and then identifies the command contained therein. In this embodiment, once the signal processing unit 134 recognizes that the switch signal from the mouse is intended to switch the state of the window, it will immediately trigger the window state switch module 136 to switch the state of the opened window that is recorded in the window recording unit 140. Besides, the window state switch module 136 will also transmit a notice signal to the display control module 138 for notifying that the switching of the windows state is completed, so that the display control module 138 may execute the change of window state according to the altered window state variable and output the result to the screen in the computer system 130. Consequently, the switch operation of computer window is completed, wherein the variable of the originally displayed window will be changed to be hiding so as to hide the window, and vice versa.

The window state setting module 142 includes a window setting interface 144 and a setting option 146. Through the input device, such as keyboard or mouse, the user can select part(s) of the opened window(s) in the setting interface 144, which is produced by the window state setting module 142, for switching the selected window's state, thereby providing the user another way to switch the window. The window state setting module 142 may check the set state of each window recorded in the window recording unit 140 for producing the window setting interface 144 which shows the records in the window recording unit 140 as a list so that the user can select the state of each window as “display” or “hide” from the setting option 146. After the user executes the switch, the window state setting module 142 will compare the setting option 146 in the window setting interface 144 with the state variable of the corresponding window in the window recording unit 140, and if the value of the state variable is different from the corresponding value recorded in the window setting interface 144 (i.e. the value in the window setting interface has been changed by the user), then the window state setting module 142 will change the window state in the window recording unit 140 according to the setting option 146 in the window setting interface 144.

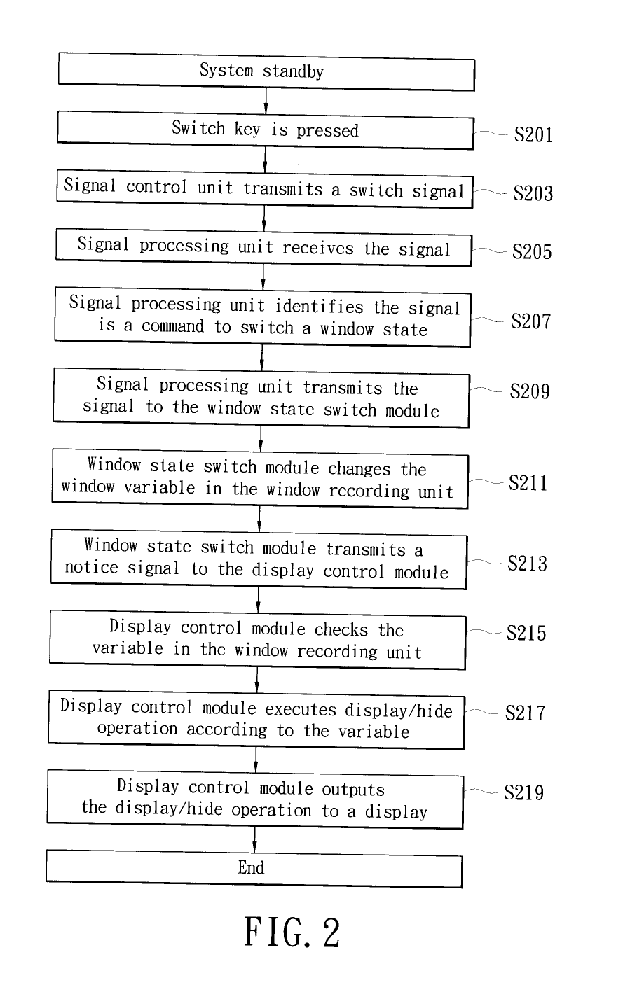

Please refer to FIG. 2, which is a flow chart showing the operation procedures of the present application. First, when the computer system 130 is kept in running and the user presses the switch key 122 on the mouse 120 (S201), the signal control unit 124 produces a switch signal to output to the window control system 132 in the computer system 130 (S203). The signal processing unit 134 inside the window control system 132 receives the switch signal (S205), and identifies that the switch signal is a command related to window state switch (S207), and then, the command is transmitted to the window state switch module 136 for driving the window state switch module 136 (S209). After the window state switch module 136 receives the command, the state variables in the window recording unit 140 are changed one by one (S211). After switching, a notice signal is transmitted to the display control module 138 (S213), and then, the display control module 138 checks the state variable of each window recorded in the window recording unit 140 (S215). Then, according to the states represented by the variables, the display control module 138 executes the hide or display operation of each window (S217) and outputs the result to show on the screen (S219).

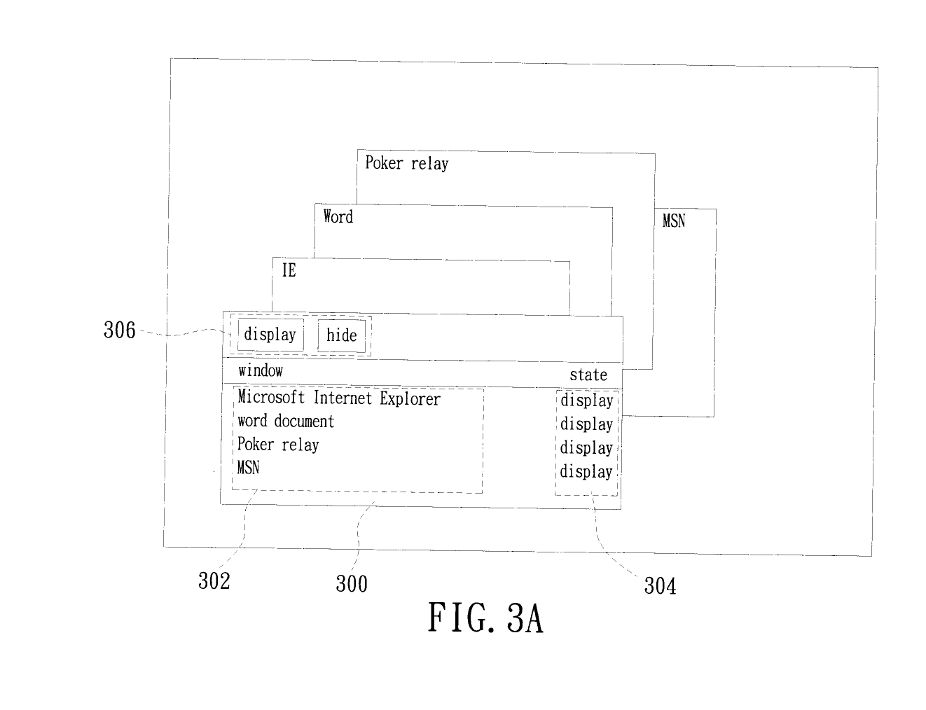

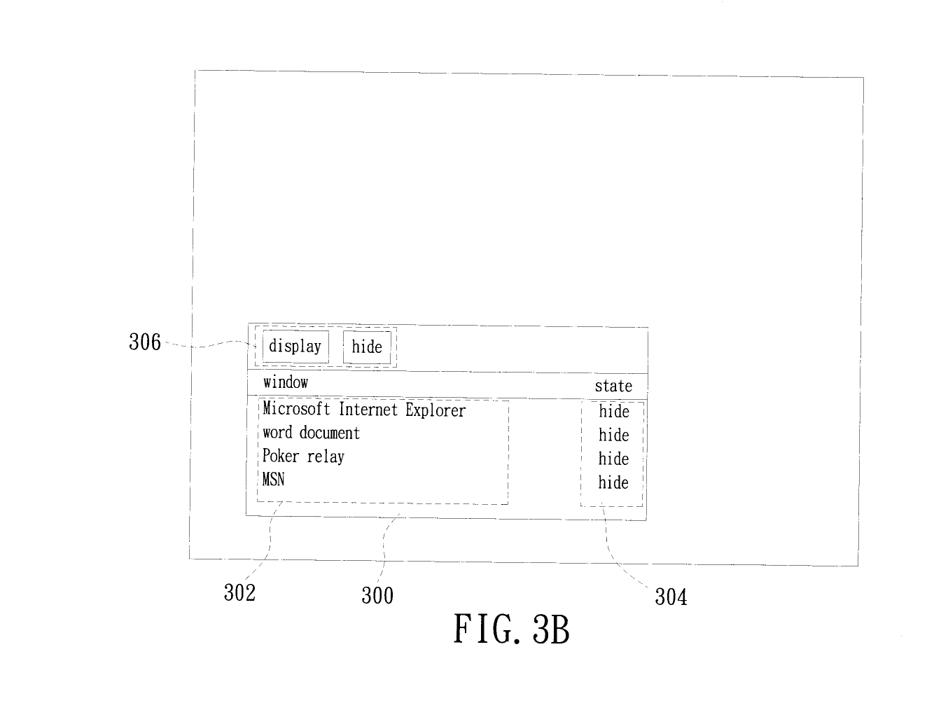

FIG. 3A shows the condition that all the opened windows are in a display state before executing the switching according to the present application. On the setting interface 300, a list which shows the window's names 302, the state variables 306 and the setting options 306 of all opened windows is included. In this embodiment, in the beginning, the states of all windows are preset as display (as indicated by 304), so that if the user does not change the setting, when the switch key 122 is pressed, all the opened windows shown on the list will be hidden, including the window name shown on the toolbar, and then, the states of windows on the list are changed to be “hide” (as shown by 304 in FIG. 3B). If the user wants to release the hide state, he or she only needs to re-press the switch key on the mouse.

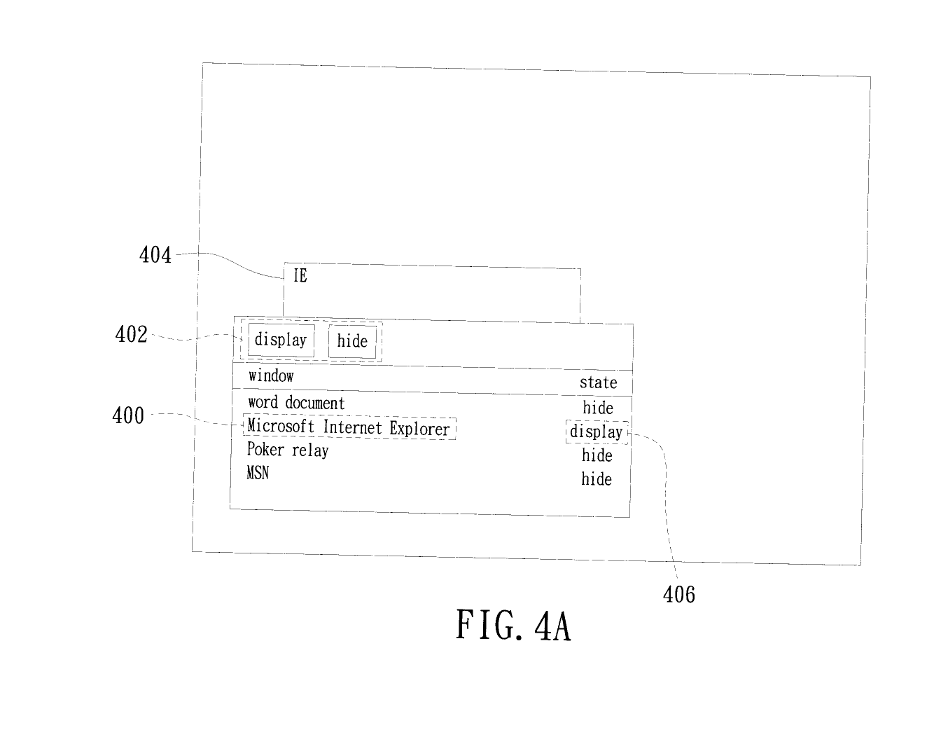

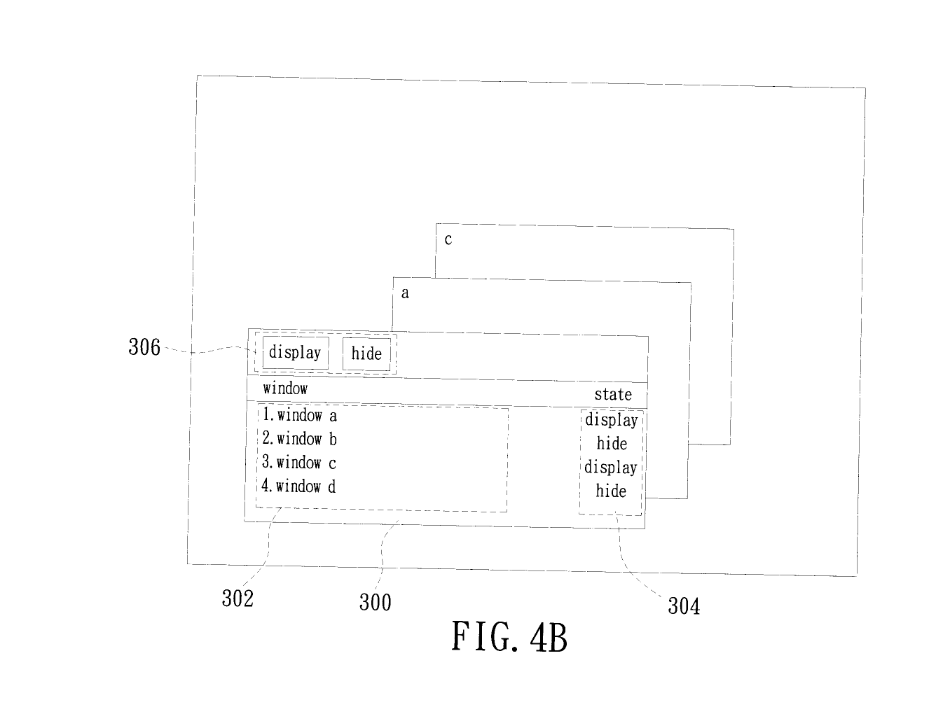

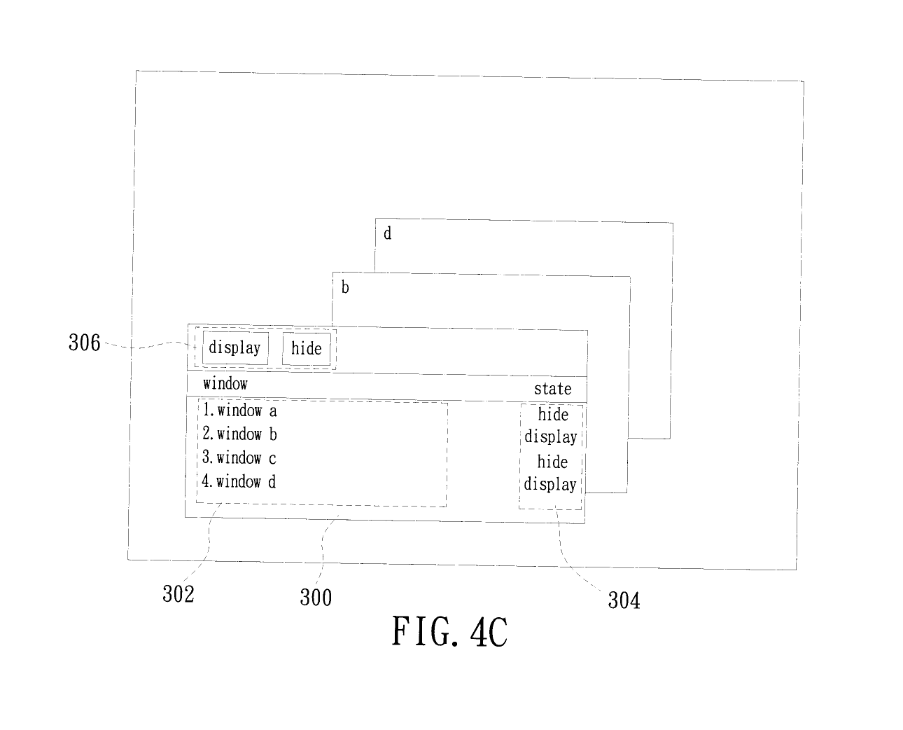

FIG. 4A is a schematic view showing that the settings of parts of the windows are changed according to the present application. The user selects the name of the window 400 and then selects the state to be changed which, in this embodiment, is “display” 402, so that the selected window (for example, a browser 404) will be shown on the screen and the state variable of the window will also be changed as “display” 406.

FIG. 4B is a schematic view showing that parts of the windows are set to hide. After setting, parts of the opened windows in the computer system 130 which are set to be “display” will be shown on the screen, such as window a and window c, and those are set to be “hide” will not be shown on the screen, namely, window b and window d. FIG. 4C is a schematic view showing the situation after pressing the switch key 122 according to the settings in FIG. 4B. As shown, all the displayed windows and hidden windows and the variables recorded in the system are opposite to the FIG. 4B.

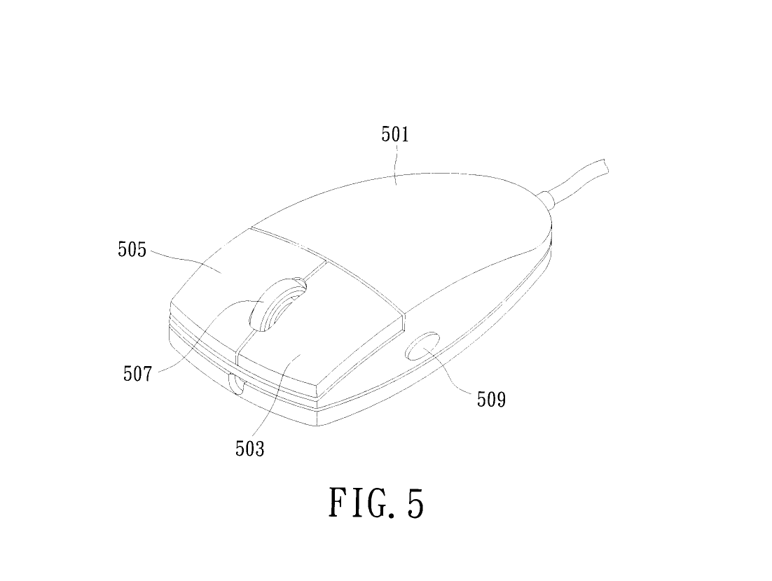

FIG. 5 is a schematic view showing the mouse 501 according to the present application. Except the left key 503, the right key 505 and the middle key or wheel 507, the mouse further includes a switch key 509, so that the user can achieve the operation through pressing the switch key 509.

It is to be understood, however, that even though numerous characteristics and advantages of the present application have been set forth in the foregoing description, together with details of the structure and function of the application, the disclosure is illustrative only, and changes may be made in detail, especially in matters of shape, size, and arrangement of parts within the principles of the application to the full extent indicated by the broad general meaning of the terms in which the appended claims are expressed.

What is claimed is:

1. A window switch system, suitable for a computer system, for switching windows in the computer system, comprising:
a mouse, having a switch key and a signal control unit, wherein the signal control unit outputs a switch signal as the switch key is pressed; and
a window control system, mounted in the computer system, comprising:
a window recording unit, for recording opened windows in the computer system and a variable representing the state of the opened window, wherein the variable is changed between a value representing the display state and a value representing the hide state;
a display control module, for executing a display operation or a hide operation of the opened window according to the corresponding variable recorded in the window recording unit;
a window state switch module, for changing the variable recorded in the window recording unit and controlling the display control module to execute the display operation or the hide operation according to the changed variable; and
a signal processing unit, for receiving the switch signal and, according thereto, causing the window state switch module to change the variable recorded in the window recording unit.

2. The window switch system as claimed in claim 1, wherein the switch signal outputted by the signal control unit is identified by the signal processing unit in the window control system.

3. The window switch system as claimed in claim 1, wherein the display control module displays the opened window on the screen of the computer system or hides the opened window in accordance with the variable recorded in the window recording unit.

4. The window switch system as claimed in claim 1, wherein the window state switch module generates a notice signal after changing the variable recorded in the window recording unit.

5. The window switch system as claimed in claim 4, wherein the display control module receives the notice signal and, according thereto, accesses the variables in the window recording unit, and executes the display operation or the hide operation to the opened window in accordance with the respective variable.

6. The window switch system as claimed in claim 1, characterized in that, the window control system further comprises:
a window state setting module, for generating a window setting interface according to the variables in the window recording unit, wherein the window setting interface comprises, windows, the state variables and a setting option including hide and display options.

7. The window switch system as claimed in claim 6, wherein the window state setting module compares the settings modifiable by the user in the window setting interface with the variables of the respective windows in the window recording unit, and changes the variables of the respective windows in the window recording unit if changed by the user.
